(19) United States
(12) Patent Application Publication
(10) Pub. No.: US 2017/0017561 A1
(43) Pub. Date: Jan. 19, 2017

(54) SOFTWARE DETECTION METHOD AND DEVICE

(71) Applicant: Beijing Qihoo Technology Company Limited, Beijjing (CN)

(72) Inventors: Lu ZHANG, Beijing (CN); Haoqiu ZHANG, Beijing (CN); Xi CHEN, Beijing (CN); Yiping LIU, Beijing (CN)

(73) Assignee: Beijing Qihoo Technology Company Limited, Beijing (CN)

(21) Appl. No.: 15/124,300

(22) PCT Filed: Dec. 30, 2014
(86) PCT No.: PCT/CN2014/095465

§ 371 Date: Sep. 7, 2016

(30) Foreign Application Priority Data
Mar. 7, 2014 (CN) 201410083400.3

(51) Int. Cl. G06F 11/36; G06F 17/30

(52) U.S. Cl. CPC G06F 11/3608; G06F 17/30598

(57) ABSTRACT

Provided are a software detection method and device. The method comprises: matching software information about software to be detected with information in one or more pre-set software problem categories to perform detection (S501), wherein the software problem categories are obtained by classifying one or more problems existing in the software, and each software problem category contains problem information related to one or more problems under the category; and if the software information about the software to be detected is successfully matched with the problem information in the one or more software problem categories, determining that the software to be detected has one or more problems under the corresponding one or more software problem categories (S502), so that a conclusion that the software has a problem can be quickly and accurately made without specifically scanning all support files or corresponding assemblies of each piece of software one by one, thereby being able to quickly find a problem before the operation of the software, guaranteeing the security of user software, reducing the system pressure of a user terminal, and improving the user experience.

### FIELD OF THE DISCLOSURE

The present disclosure relates to the field of computer detection, and particularly to a software detection method and device.

### BACKGROUND OF THE DISCLOSURE

As computer technologies develop swiftly and various terminals prevail, diverse software running in terminals is getting more and more abundant. However, validity and safety in use of software is gradually threatened at the same time, which urgently calls for a processing method capable of quickly detecting validity and safety in use of software.

For example, upon software operation, a user is often confronted with problems such as insufficient computer memory, too long software activation duration and failure to play audio and video. These problems usually cannot be handled by the user, and it is usual that the user tends to handle after the problems occur. This will cause serious economic loss due to untimely processing, or problems like abnormal malfunction of the computer due to improper processing.

With regard to the above-mentioned software problems, in the prior art it is usual to detect the software when the user finds failure to operate normally upon using the software, and thereby judge whether the software includes any problem to be solved. Furthermore, during detection, the user must scan all support files or corresponding components in the software one by one by using a specific check software to complete detection of the software, and that requires higher level of professional knowledge and causes higher operation costs.

### SUMMARY OF THE DISCLOSURE

In view of the above drawbacks, solutions of the present disclosure are proposed to provide a software detection method and device, a computer program and a computer-readable medium which are intended to overcome the above drawbacks, or at least partially solve technical problems about effectively performing quick detection for software without interfering in the run of an operating system to improve software safety.

According to an aspect of the present disclosure, there is provided a software detection method, comprising: matching software information about software to be detected with problem information in one or more pre-set software problem categories, wherein the software problem categories are obtained by classifying one or more problems existing in the software, and each software problem category contains problem information related to one or more problems under the category; and if the software information about the software to be detected is successfully matched with the problem information in the one or more software problem categories, determining that the software to be detected has one or more problems under the corresponding one or more software problem categories.

According to another aspect of the present disclosure, there is provided a software detection device, comprising: a detecting module configured to, match software information about software to be detected with problem information in one or more pre-set software problem categories; a determining module configured to, if the software information about the to-be-detected software is successfully matched with the problem information in the one or more software problem categories, determine that the to-be-detected software has one or more problems under the corresponding one or more software problem categories; a presetting module configured to, obtain the software problem categories by classifying one or more problems existing in the software, each software problem category containing problem information related to one or more problems under the category.

In an embodiment of the present disclosure, there is provided a computer program comprising a computer-readable code, the software detection method being executed when the computer-readable code is run on an electronic equipment.

In an embodiment of the present disclosure, there is provided a computer-readable medium, wherein the computer-readable medium stores the aforesaid computer program.

According to the software detection solutions of the present disclosure, software information about software to be detected can be matched with corresponding to problem information representing one or more software problems in each pre-set software problem category. When the software information of the to-be-detected software is successfully matched with the problem information, it is determined that the to-be-detected software has the software problem represented by the problem information and the software problem belongs to a corresponding software problem category. As such, the detection manner of using the software information of the to-be-detected software to match with the problem information can quickly and accurately obtain the problem existing in the software without need to specifically scan all supporting files or corresponding components of each software one by one, and furthermore, the detection speed is quick and normal operation of the operating system cannot be disturbed. Furthermore, the detection manner employing software information matching can perform detection processing in advance for the to-be-detected software without running the to-be-detected software, i.e., can find a problem quickly before the software runs, thereby guaranteeing safety of the user's software and lessening system pressure of the user's terminal. Furthermore, the solutions of the present disclosure exhibit simple operations and lower operation cost, do not require the user to operate and needn't require the user to have higher level of computer expertise, and facilitate improvement of user experience.

Again, classifying one or more software problems into categories and recording corresponding problem information representative of software problem in each category can not only assist in quickly detecting the problem existing in the software and determining the corresponding category, but also can list detected software having or even not having software problems in different categories, display them visually to the user according to an entry of category and further improve the user's experience.

The above description only summarizes technical solutions of the present disclosure. The present disclosure may be implemented according to the content of the description in order to make technical means of the present disclosure more apparent. Specific embodiments of the present disclosure are exemplified to make the above and other objects, features and advantages of the present disclosure more apparent.

### BRIEF DESCRIPTION OF DRAWINGS

Various other advantages and merits will become apparent to those having ordinary skill in the art by reading through the following detailed description of preferred embodiments. Figures are only intended to illustrate preferred embodiments and not construed as limiting the present disclosure. In all figures, like reference number denote like parts. In the figures:

FIG. 1 illustrates a specific flow chart of an embodiment of a software detection method according to the present disclosure;

FIG. 2 illustrates a flow chart of a method of building software problem categories in an embodiment according to the present disclosure;

FIG. 3 illustrates a structural view of an embodiment of a software detection device according to the present disclosure;

FIG. 4 illustrates a schematic view of displaying a software problem in an embodiment according to the present disclosure;

FIG. 5 illustrates a flow chart of a software detection method according to an embodiment of the present disclosure;

FIG. 6 illustrates a structural schematic view of an electronic equipment for executing the method of the present disclosure;

FIG. 7 illustrates a schematic view of a memory unit for maintaining or carrying a program code for implementing the method according to the present disclosure.

### DETAILED DESCRIPTION OF PREFERRED EMBODIMENTS

Exemplary embodiments of the present disclosure will be described in more detail with reference to figures. Although the figures show exemplary embodiments of the present disclosure, it should be appreciated that the present disclosure may be implemented in various forms and should not be limited by embodiments described here. On the contrary, these embodiments are provided to make the present disclosure more complete and convey the scope of the present disclosure completely to those skilled in the art.

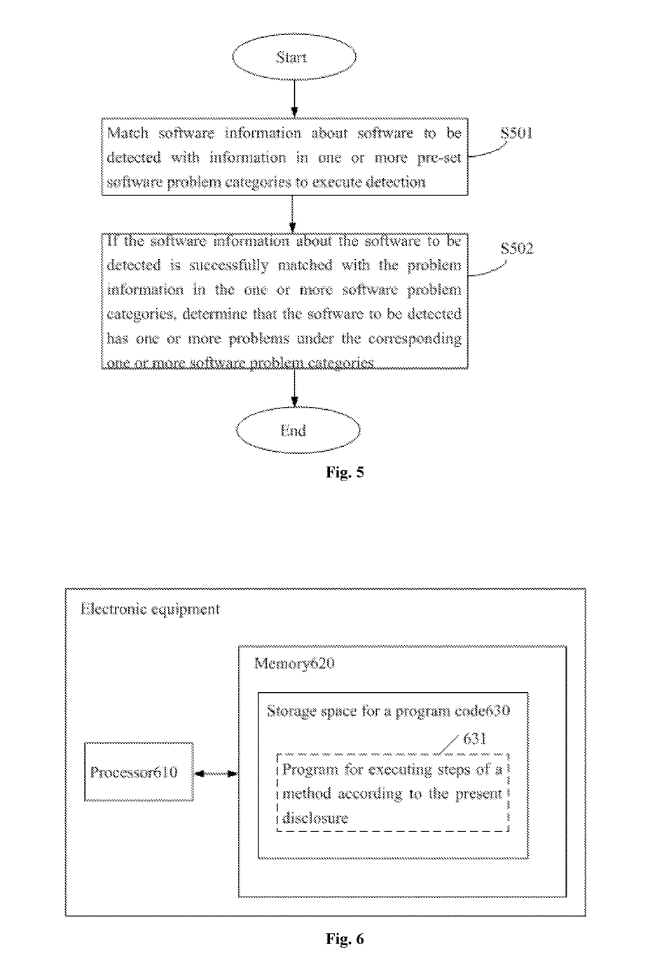

As shown in FIG. 5, it illustrates a flow chart of a software detection method according to an embodiment of the present disclosure. The method comprises:

step S501, matching software information about software to be detected with information in one or more pre-set software problem categories;

step S502, if the software information about the software to be detected is successfully matched with the problem information in the one or more software problem categories, determining that the software to be detected has one or more problems under the corresponding one or more software problem categories. Wherein the software problem categories are obtained by classifying one or more problems existing in the software, and each software problem category contains problem information related to one or more problems under the category.

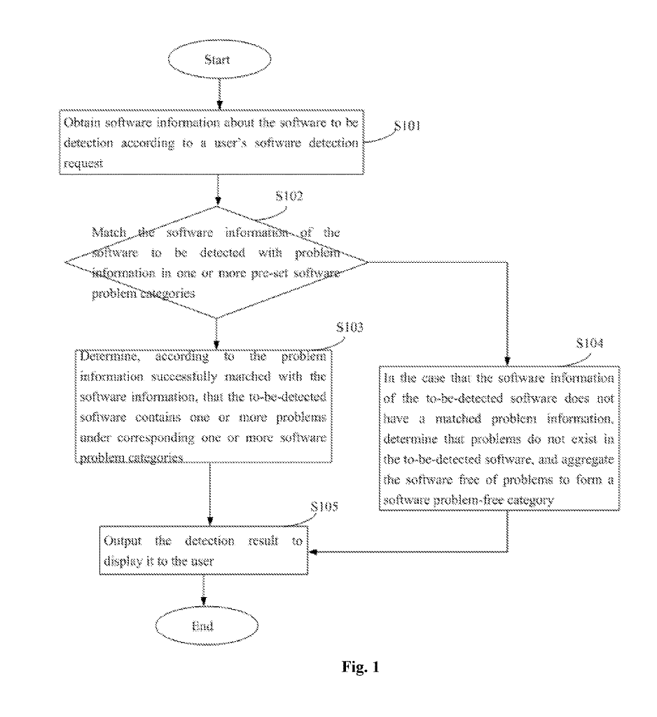

The software detection method according to the embodiment of the present disclosure will be described in more detail. FIG. 1 illustrates a specific flow chart of a more specific data processing method according to an embodiment of the present disclosure.

In step S101, software information about the software to be detected is obtained according to the user's software detection request.

According to an embodiment of the present disclosure, the software detection request is a user request sent by the user to a server (the server may be placed locally or at cloud) to perform detection for safety of application software already at least currently installed in the user's terminal equipment and/or system software in the terminal equipment. The terminal equipment is for example a computer or a mobile phone. Specifically, the detection request may be sent by the user via an interface (e.g., a browser or other interface application programs, etc.) on the user's terminal equipment for interacting with the server by triggering a command (e.g., triggering a “detect” button of an interface application program) upon activation or operation.

Wherein the software to be detected is various software present (e.g., installed or stored) in the user's terminal equipment, and it at least comprises application software and/or system software currently already installed in the user's terminal equipment.

Software information refers to various information of the software which represents fixed characteristics of the software and running (use) situations. The software information at least comprises basic information and/or use information of the software. Specifically, the basic information of the software is diverse information which mainly represents fixed characteristics of the software, such as version number, space occupation, applicable installation system, applicable plug-in information and latest update time of the software, etc. Use information of the software is diverse information which mainly represents the running/use situations of the software, such as installation information of the software (e.g., installation time, installation component or the like), running information of the software (e.g., an activation state each time, abnormal running state, namely, abnormal state occurring upon use or invocation, or other running state, etc), software registry invoking information (e.g., invoking time, invoking error or the like), or state information of buffer related to software (e.g., trash buffer state, etc) or the like.

In an embodiment, the server receives the software detection request from the user, and responds to the request: firstly the server obtains software log of software to be detected from the user's terminal equipment, and then extracts software information of the software from the software log.

In step S102, the software information of the software to be detected is matched with problem information in one or more pre-set software problem categories.

In this way, it is feasible to judge whether the software information of the software to be detected corresponds to one or more problem information, and thereby determine whether there exists a software problem as indicated by the corresponding problem information.

According to an embodiment of the present disclosure, the server responds to the user's request. In order to execute detection of all or partial software on the user's terminal equipment, the server employs a manner of matching the software information of these obtained software to be detected with problem information in the pre-set software problem categories, quickly detects whether these software information correspond to problem information under respective software problem categories to thereby determine whether a problem exists in the to-be-detected software which provides the software information, and which type of problem exists.

Wherein, the problem information is also software information, and specifically may be one problem information, namely, one piece of software information or a combination of several pieces of software information related to one or more problems existing in the software, and furthermore, the problem information is recorded in the software problem categories.

Wherein, the software problem categories are obtained by classifying one or more problems existing in the software, and each software problem category contains problem information related to one or more problems under the category. Specifically, different problems exist in the software. Several problems having the same property or characteristic may be directed into the same category. Each category contains “problems” of software under the category, and problem information related to these “problems” is recorded under each category (as shown in Table 1). Wherein “problems” may refer to software defects, software problems which are to be processed and related to safety (e.g., unsafe due to a too low version) or the like.

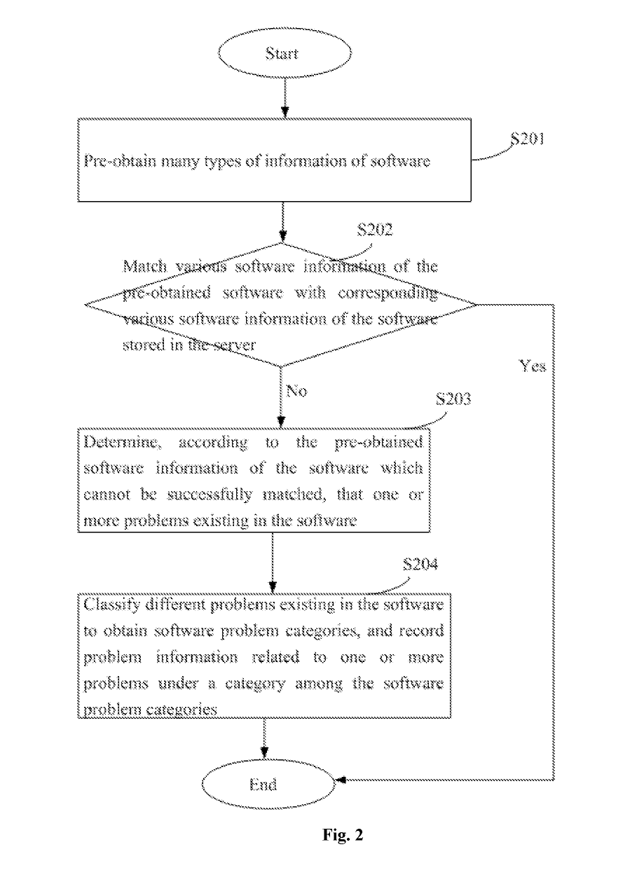

Obtainment of software problem categories may specifically be a classification pre-processing procedure or a pre-setting procedure. This is an embodiment described hereunder with reference to FIG. 2 which specifically describes the pre-setting of the software problem categories.

As such, the server obtains software and software information regularly or irregularly, and obtains various software problems by matching the obtained software information with the software information of the software stored in the server, and performs classification and records problem information on this basis, namely, performs pre-processing, to form software problem categories 1-N (N is a natural number; classification may be made in a fixed manner or in a variable way according to actual pre-processing situations).

In an embodiment of the present disclosure, the software information about the software to be detected obtained by the server from the user's terminal equipment may be matched with problem information under each software problem category one by one. When part or all software information of the software to be detected successfully matches with part or all problem information in a certain software problem category or several certain software problem categories, it can be determined that the software to be detected includes corresponding software “problems” under a corresponding software problem category. Wherein, the matching procedure is a procedure of detecting the software to be detected.

Furthermore, regarding detection of to-be-detected software on the user's terminal equipment, the software information of each to-be-detected software may be matched with problem information under each software problem category in turn or simultaneously. If part or all software information possessed by one or more to-be-detected software can be successfully matched with the problem information under one software problem category, this indicates that the one or more to-be-detected software include corresponding one or more software problems under this software problem category.

This avoids the problem that the user needs to detect software one by one to learn about the problem existing in the software. Matching software information of a plurality of to-be-detected software simultaneously can further improve the detection efficiency.

In addition, if problem information matching with the software information is not found after all software information of a to-be-detected software are matched with all problem information in all software problem categories, it may be determined that there is no problem with the to-be-detected software. Furthermore, an individual software problem-free category will be formed for software without problem, so that the user can learn that the software on the current terminal equipment is free of problems, in a normal state and safe and needn't be updated or remedied.

Hereunder, detection of audio-video software Move is taken as an example for illustration. The user U, through a software detection interface application program, sent a detection request to the server to detect the audio-video software Move and after receiving the user U's detection request, the server begins to detect the Move software in response to the user' U's request. The server obtains software information of Move software “Move” on the terminal of the user U. The software information of Move includes: version number 1.23.4.0, size 27.65M, systems Win8.1/8/7/XP on which the software is adapted to be installed, and a plug-in EX. Then, assuming there are two software problem categories (Category I and Category II), the server matches the software information of the Move software with problem information in each software problem category among the two pre-set software problem categories. Wherein Category I is “upgrade/update software” and includes problem (I-1) that the version is too low, and the corresponding relevant problem information is the low version number of Move software and/or time of installing and using Move (cycle), and low version number of other software and/or time of installing and using the software (cycle). Category II is “safety threat resulting from software bundling/carrying” and includes problem (II-1) about software bundling, and the corresponding relevant problem information is EX plug-in of Move and plug-ins of other software; problem (II-1) about software carrying, and the corresponding relevant problem information is download link application program of one or more other software. The software information of Move obtained by the server from the user U can successfully match, in turn, with the version number “Move 1.23.4.0” recorded in software problem category I and “Move plug-in EX” recorded in the software problem category II.

If the software information successfully matches with the problem information during matching step of step S102, the method will proceed to step S103. If the software information fails to match with the problem information during matching step of step S102, i.e., the software information of the to-be-detected software fails to match with any problem information in any of the software problem categories, the method will proceed to step S104.

In step S103, it is determined according to the problem information successfully matched with the software information that the to-be-detected software includes one or more problems under corresponding one or more software problem categories.

As shown in Table 1, when the software information of the to-be-detected software is A1 and when it successfully matches with problem information A1 under the software problem category I, namely, (A1=A1), it can be determined that problem al under the software problem category I as represented or indicated by A1 exists in the to-be-detected software.

Furthermore, if one piece of software has many types of software information successfully matching with many types of problem information, the software might include many problems to be processed, and the many problems might belong to different categories.

In the above example about detection of Move software, if the software information “Version number: Move 1.23.4.0” of the Move software on the terminal of the user U successfully matches the problem information “Version number: Move 1.23.4.0”, and the software information “Move plug-in Ex” successfully matches the problem information “Move plug-in Ex”, the problem (I-1) about software update and upgrade exists in Move, i.e., the software Move cannot be normally used unless it is updated, and the problem (II-1) about software bundling exists in the software Move, i.e., if not timely handled, the user will be monitored by other strange equipment due to software bundling, thereby causing threatens to information safety. Furthermore, the two problems respectively belong to software problem categories I and II.

Wherein, the manner of matching the software information of the to-be-detected software with the problem information in each software problem category may be judged by using a preset threshold or the basic information to further invoke. However, the present disclosure is not limited to this.

For example, the to-be-detected software is a certain browser software, and the software information of the browser comprises basic information “the latest version V123.6”, “space occupation 37.23M”, “update time 2014.01.01” and “adapted to be installed on Software-series operating systems”, and the software information of the browser further comprises use information “registry cyclic invocation”.

Currently, the above software information of the browser software is matched with problem information in preset 13 software problem categories one by one. Wherein, the preset 13 software problem categories include: a) software is bundled and installed, b) no use of the software in a long term, c) too many software of the same type are installed, d) a temporary file is not removed after the software runs, e) the software occupies too many resources, f) the software automatically runs upon startup, g) lack of requisite software, h) lack of software running environment, i) default software is not configured, j) a default browser and homepage are not locked, k) software assessment is too low, l) advertisement pops up when the software is running, m) the software is not updated in the long past.

During the one-to-one matching, the software information of the browser software successfully matches with the problem information that the browser occupies a space of 37.23M as stored in the e) software problem category, at this time the browser is confirmed as having a software problem under the software problem category e) “the software occupies too many resources”, and the software problem is recorded in a to-be-displayed area.

Matching continues between the software information of the browser software and problem information in h)-m) software problem categories. When the software information of the browser software is matching with the problem information in the software problem category “j) a default browser and homepage are not locked”, basic information such as “the latest version of the browser software is V123.6” and “update time 2014.01.01” is used to further invoke or obtain the use information such as registry invocation information of the browser software so as to match with the registry invocation information (namely, problem information) of the error-existing browser software recorded in the j) software problem category. If the matching is successful, it is determined that unlocked state problem exists in the browser software which is currently detected, and meanwhile the software problem in the j) category is recorded in the to-be-displayed area.

After determining the problem obtained from the detection and the corresponding software problem category, the method proceeds to step S105.

At step S104, in the case that the software information of the to-be-detected software does not have any matched problem information, it is determined that problems do not exist in the to-be-detected software, and the software free of problems are aggregated to form a software problem-free category. If all software information of the to-be-detected software is not successfully matched with any problem information recorded in any software problem category, it is determined that the to-be-detected software does not have a problem. Furthermore, these to-be-detected software which is already detected and has no problems after detection are aggregated and directed to a uniform category, namely, a software problem-free category so that they are displayed to the user in a centralized manner after completion of the detection, so that the user can quickly and clearly know that these software are problem-free software.

For example, detection is performed on the to-be-detected software: a certain office software A, a chat software B and a browser software C, and the detection result is as follows: software information of software A and software information of software C is respectively matched with problem information in each software problem category one by one, and when matching is unsuccessful, it may be determined that the two software do not have software problems; the software information of software B is matched, one by one, with the problem information in each software problem category, and it is successfully matched with the problem information in the software problem category “software update”, then it may be determined that the software B has “software update” problem. Software A and software C are directed to “software problem-free category”, whereas software B is directed to the software problem category “software update corresponding to the matched problem information”.

After determining the problem obtained from the detection and corresponding software problem category, the method proceeds to step S105.

At step S105, the detection result is output and displayed to the user.

In one embodiment, software under the same software problem category among software which is already determined as having problems is aggregated into a display entry. A software problem category corresponds to a display entry, and each display entry displays a corresponding software problem category and one or more software belonging to the software problem category. In addition, it is also feasible to aggregate software determined as not having problems to a display entry of the software problem-free category (namely, an individual display entry).

The detection result is finally obtained after the to-be-detected software is detected in a matching way, and determination is performed, according to the match results, as to whether there is a problem, which software problem exists and which software problem category the software problem belongs to, and the detection result is recorded in the display area for display to promote the user that which class of software problems the displayed software belongs to. The detection result may be displayed in an entry manner. Under each entry, software having a problem is displayed. Furthermore, under each entry, a processing function may be set corresponding to the displayed software having a problem, e.g., a button “process the software problem” is set to indicate that the user may handle the problem existing in the software.

As shown in FIG. 4, under the display entry of each software problem category, each software detected as having the problem under the category is displayed, and repair manners such as buttons like “uninstall” and “details” corresponding to the software with the problem are configured beside each software, to prompt the user that he may process the in-question software in an “uninstalling” manner or a manner of viewing detail, and the like.

In the case that many types of software exist under the same software problem category, they may be displayed under one display entry, whereas software is detected as having problems under multiple software problem categories, multiple display entries may be formed according to the multiple software problem categories which the problems belong to. All software detected as not having a problem are directed into one category and placed under a display entry of one software problem-free category and output and displayed to the user.

When the detection result is displayed, one display entry of the software problem-free category is always displayed except for an extreme case, namely, the case that all the detected software have problems (the display entry may be displayed as “empty” in the extreme case).

An example of a process of building software problem categories in the detection method according to the present disclosure will be described in conjunction with FIG. 2. This is only an example and not intended to limit other implementation modes of the present disclosure.

Referring to FIG. 2, it illustrates a flow chart of a method of pre-setting software problem categories according to an embodiment according to the present disclosure.

At step S201, many types of information of software are pre-obtained.

In an embodiment, the server obtains one or more types of software information of one software, e.g., software information A1, A2, A3 and A4 of software A, wherein the information of the software may be obtained in a way that the server extracts each type of software information of each software from software supplied by the user or developer, or the server collects software log in a manner that the client submits software log regularly (the software log is a log record carried by each software in its installation folder and it is stored in the installation folder of the software for ever; the log record records all information ranging from development to installation to subsequent application of the software, for example, version number, space occupation size, a system adapted to be installed, and plug-in information). Furthermore, the server extracts software information of the software according to the collected software log of various software by taking registration information and running state of the software in the software log and related information that may affect the run/use of the software as a core.

Wherein obtaining various information may mean pre-setting a time period to obtain information in a certain time period, for example, version number information. Whether the software has a problem may be accurately detected by requiring version number information in multiple time periods. Regarding a manner of obtaining information in software problem categories, the present disclosure is not limited to the above method.

All information of software from installation to use is recorded in the software log, and the software log is always stored in the installation file of the software installed by the user. Specifically, once the user installs or uses certain software, the installation time, information in an installation component or plug-in information, a run state, and run time of the software all are recorded in a corresponding software log. Since the software log can record the situations whenever the user uses the software, a portion of repeated information might be stored. Therefore, the software information needs to be extracted by taking registration information and running state of the software in the software log and related information that may affect the run/use of the software as a core. For example, for the software version number as the software information, only the latest version number needs to be extracted to judge whether the software needs to be updated.

Therefore, the software log of a relevant software may be obtained by collecting the request filed by the user to the server to perform online detection for one or more already-installed or applied software, or the corresponding software log may be parsed from a software installation folder. Hence, respective software information about various software may be obtained from the software log.

At step S202, various software information of the pre-obtained software is matched with corresponding various software information of the software stored in the server.

In an embodiment, the server may match the obtained one or more software information of the software with one or more software information stored in the server and corresponding to the one or more software information one to one. For example, software information A1, A2, A3 and A4 of the software A is matched with software information A1′, A2′, A3′ and A4′ of software A stored in the server one to one, that is A1 is matched with A1′, A2 is matched with A2′, A3 is matched with A3′, and A4 is matched with A4′. If A1 is successfully matched with A1′, A1=A1′; if they are not successfully matched, A1≠A1′.

Wherein the server can store relevant information of all software and perform software information and update of the corresponding software according to the software log provided by the developer. Hence, the collected software information about various software may be matched with software information of the same software stored in the server so as to predict there from various problems that might exist with the software.

For example, pre-obtained software information of one software S is: version number V2.0, and components are Z1, Z2, ZB1, and software information of software S stored in the server are version number V2.2, and components are Z1, Z2Z, ZBD. After the aforesaid pre-obtained software information of the software is matched with the aforesaid software information of the software pre-stored in the server, it may be concluded that they fail to match with each other in both version number and components. Hence, the software having the two software information “version number V2.0” and “components are Z1, Z2, ZB1” might be confronted with problems that the software needs to be updated or there is a malicious plug-in. Regarding the processing for failure to match, the flow may proceed to S203.

At step S203, one or more problems existing in the software are determined according to the pre-obtained software information of the software which cannot be successfully matched.

In an embodiment, if the pre-obtained one or more software information of the software cannot be successfully matched with corresponding one or more software information of the same software stored in the server, it may be determined according to the pre-obtained one or more software information of the software that the software has one or more problems.

The pre-obtained one or more software information of the software may serve as problem information related to existence of one or more problems. For example, software information A1 is different from A1′, software information A2 is different from A2′, software information A4 is different from A4′, and software information A3=A3′, that is to say, software information A1, A2 and A4 are not successfully matched. It may be determined according to the software information A1 that the software A has a problem a1, it may be determined according to the software information A2 that the software A has a problem a2, and it may be determined according to software information A2 and A4 that the software A has a problem a24. That is to say, the software A has three problems, namely, a1, a2 and a24. Furthermore, the software information A2 is considered as problem information A1 corresponding to problem a1, software information A2 is considered as problem information A2 corresponding to problem a2, and software information A2, A4 are considered as problem information A2, A4 corresponding to the problem a24 (that is, the problem a24 is determined by combining the two software information A2, A4; the two software information are both problem information and simultaneously indicate that problem a24 will occur in the software).

If all the software information are successfully matched, this indicates that none problems exist in the software.

Therefore, if the pre-collected software information of various software cannot be successfully matched with corresponding software information of the same software stored in the server, the pre-collected unmatched various software information of various software is extracted for prediction of software problem categories.

Further referring to the preceding example, the pre-obtained software S and the software S stored by the server do not match each other in terms of version number, the version number V2.2 of software S on the server is higher than the version number V2.0 of the pre-obtained software S, it may be determined that if software S is on the user's terminal, it might be confronted with the problem that it needs to be updated (i.e., the lower version needs to be updated or upgraded).

At step S204, different problems existing in the software are classified to obtain software problem categories, and problem information related to one or more problems is recorded under a category among the software problem categories.

In an embodiment, one or more problems determined by software information are classified according to similarity and common properties (identical nature or characteristics) to obtain software problem categories, and problem information related to one or more problems is directed to and recorded in each software problem category.

A manner is to extract software information of these pre-obtained software whose software information is different from software information of each software stored in the server, and aggregate these extracted software information, and direct problems with identical or similar nature or characteristics and corresponding software information into one category. For example, problems a1, a2 and a24 are classified: problem a1 goes to one category, namely, software problem category I, problem a2 goes to a category, namely, software problem category II, and problem a24 goes to a category, namely, software problem category IV; and several software information A1, A2, A4 of software S which cannot be successfully matched with software S stored in the server are extracted for aggregation, wherein software information A1 corresponding to the problem a1, namely, problem information A1, is recoded in category I, problem information A2 corresponding to problem a2 is recorded in category II, and problem information A2 and A4,(A2&A4), corresponding to problem a24 is recorded in category IV, as shown in Table 1 below:

TABLE 1

| | | |
|---|---|---|
| Software problem category | Problems a1, b2, c3 | A1, B2, C3 |
| I | | |
| Software problem category | Problems b1, c1, d12, a2 | B1, C1, D1&D2 |
| II | | |
| Software problem category | Problem c2 | C2 |
| III | | |
| Software problem category | Problem a24 | A2&A4 |
| IV | | |

Wherein a2, b1, b2, c1, c2, c3 and d12 are problems found after other software matches and directed to corresponding categories, and record corresponding software information, namely, problem information A2, B1, B2, C1, C2, C3, D1&D2 (D1 and D2).

The software problem categories table (as shown in Table 1) is formed after a procedure including matching, determining problems and classifying. Through this table, it is possible to predict which problems possibly exist in the software. For example, if software information of a certain user's software S1 such as version number C1 and plug-in EX fails to match with the version number C1′ and plug-in EX′ of the corresponding software S1 stored in the server, it is determined that the software is confronted with safety problems or its own defective problems such as updating or bundling, the two problems c1 and ex of the software S1 are classified into two categories (an update category and an advertisement and plug-in category) and problem information C1 and EX is recorded therein, and it is possible to predict that other users' software S1 might be confronted with the two classes of problems.

The following software problem categories may be obtained in this manner of predicting software problems and classifying the software problem: a category that too many software of the kind is installed, a category that a temporary file is not removed after a software runs, a category that too many resources are occupied when the software is running, a category that the software automatically runs upon power on, a category that requisite software is absent, a category that a software running environment is absent, a category that a default software is not set, and other software problem categories.

In this way, it is feasible to prompt the user in real time that he may solve the software problem before the software is confronted with the problem, thereby avoiding unnecessary loss.

So far, a procedure of a specific embodiment of the software detection method according to the present disclosure is described in conjunction with FIG. 1 and FIG. 2. The detection is performed by matching the obtained software information of the software which the user requests to detect with information in one or more preset software problem categories, thereby determining a problem existing in the detected software according to the corresponding software problem category which is successfully matched, and effectively and quickly detecting the problem existing in the problem. Besides, purposeful display is performed according to the detection result so that the user clearly knows the problem existing in the software and performs corresponding processing for the problem.

Similar to the above software detection method, embodiments of the present application further provide a corresponding software detection device.

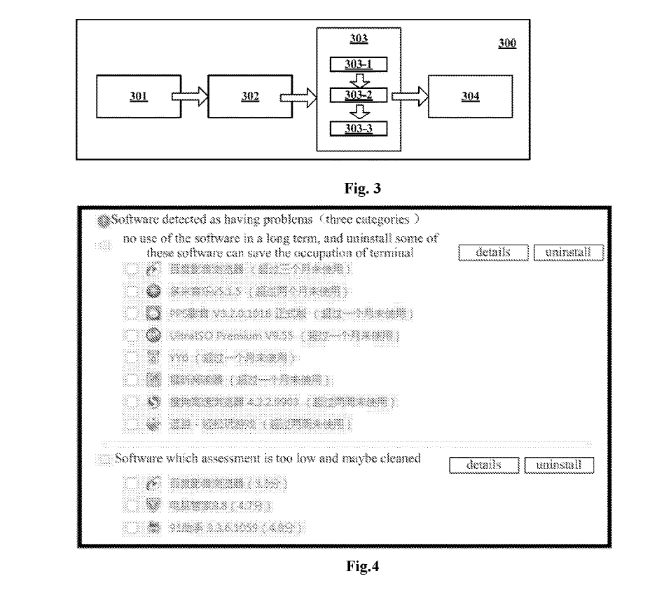

Referring to FIG. 3, it illustrates a structural block diagram of a software detection device 300 according to an embodiment of the present application. The device 300 comprises: a detecting module 301, a determining module 302, a presetting module 303 and an output module 304.

The detecting module 301 is configured to, match software information about software to be detected with problem information in one or more pre-set software problem categories, and furthermore, if the software information of the to-be-detected software is not successfully matched with any problem information in any software problem category, determine that the to-be-detected software does not have a problem; aggregate the to-be-detected software free of problems to form a software problem-free category. Reference may be made to steps S501 and S101-S102 for specific implementation modes.

The determining module 302 is configured to, if the software information about the to-be-detected software is successfully matched with the problem information in the one or more software problem categories, determine that the to-be-detected software has one or more problems under the corresponding one or more software problem categories. Reference may be made to steps S502 and S103-S104 for specific implementation modes.

The presetting module 303 is configured to, obtain the software problem categories by classifying one or more problems existing in the software, each software problem category containing problem information related to one or more problems under the category. Reference may be made to S201-S204 for specific implementation modes.

Wherein the presetting module 303 further comprises: a matching sub-module 303-1 configured to, match pre-obtained one or more software information of the software with the corresponding software information of the software stored in the server; a determining sub-module 303-2 configured to, if one or more software information fails to match with the corresponding software information of the stored software, determine one or more problems existing in the software according to the one or more software information, and regard the one or more software information as problem information related to the one or more problems; a classifying sub-module 303-3 configured to, classify the one or more problems to obtain software problem categories and record in the software problem categories problem information related to one or more problems under the categories.

The output module 304 is configured to, aggregate software under the same software problem category among software which are already determined as having problems into a display entry, wherein a software problem category corresponds to a display entry, and each display entry displays a corresponding software problem category and one or more software belonging to the software problem category, and further configured to, aggregate software determined as not having problems according to the detection result to a display entry of a software problem-free category. Reference may be made to step S105 for specific implementation modes.

The algorithm and display provided herein are not intrinsically related to any specific computer, virtual system or other devices. Various general systems may also be used together with a teaching based on this. According to the above depictions, structures required for constructing such type of systems are obvious. Besides, the present disclosure is not with respect to any specific programming language. It shall be understood that various programming languages may be used to implement the content of the present disclosure described here, and the above depictions for a specific language are intended to reveal preferred embodiments of the present application.

The description as provided here describes a lot of specific details. However, it is appreciated that embodiments of the present disclosure may be implemented in the absence of these specific details. Some embodiments do not specify known methods, structures and technologies in detail not to understand the description ambiguously.

Similarly, it should be appreciated that in order to simplify the present disclosure and help understand one or more aspects of the present disclosure, in the above depictions of exemplary embodiments of the present application, features of the present application are sometimes grouped together to an individual embodiment, figure or depiction thereof. However, the disclosed method should not be interpreted as the following intention: the claimed present disclosure claims more features than the features explicitly recited in each claim. More exactly, as reflected by the following claim set, aspects of the disclosure are less than all features of an individual embodiment disclosed previously. Therefore, the claim set conforming to a specific implementation mode is thereby explicitly incorporated into this specific implementation mode, wherein each claim itself serves as an individual embodiment of the present application.

Those skilled in the art may appreciate that modules in the apparatus in the embodiment may be changed adaptively and they are set in one or more apparatuses different from the present embodiment. Modules or units or assemblies in the embodiment may be combined into one module or unit or assembly, and besides, they may be divided into a plurality of sub-modules, subunits or subassemblies. Except that at least some of such features and/or processes or units are mutually repellent, all features disclosed in the specification (including the accompanying claims, abstract and figures) and all processes or units of any method or apparatus disclosed in this way may be combined by employing any combination. Unless otherwise stated expressly, each feature disclosed in the specification (including the accompanying claims, abstract and figures) may be replaced with an alternative feature providing identical, equivalent or similar objective.

In addition, those skilled in the art can understand that even though some embodiments described here include some features other than other features included in other embodiments, combination of features of different embodiments means being within the scope of the present application and forming different embodiments. For example, in the appended claim set, any one of the claimed embodiments may be used in an arbitrary combination manner.

Embodiments regarding parts in the present disclosure may be implemented in hardware, or implemented by software modules running on one or more processors, or implemented in their combinations. Those skilled in the art should understand that a microprocessor or digital signal processor (DSP) may be used in practice to implement some or all functions of some or all parts of the apparatus according to embodiments of the present disclosure. The present disclosure may also be implemented as an apparatus or device program (e.g., computer program and computer program product) for executing part or all of the method described here. Such programs implementing the present disclosure may be stored in a computer-readable medium, or may be in a form having one or more signals. Such signals can be obtained by downloading from the Internet, or provided on a carrier signal or provided in any other forms.

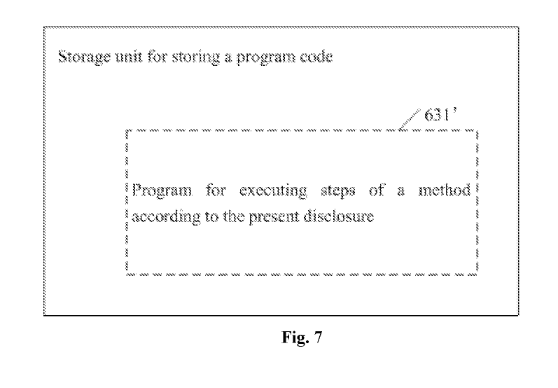

For example, FIG. 6 illustrates an electronic equipment for implementing the software detection method according to the present disclosure. The electronic equipment conventionally comprises a processor 610 and a computer program product or computer-readable medium in the form of a memory 620. The memory 620 may be a flash memory, EEPROM (Electrically Erasable Programmable Read-Only Memory), EPROM, hard disk or ROM-like electronic memory. The memory 620 has a storage space 630 for a program code 631 for executing any step of the above method. For example, the storage space 630 for the program code may comprise program codes 631 respectively for implementing steps of the above method. These program codes may be read from one or more computer program products or written into the one or more computer program products. These computer program products comprise program code carriers such as hard disk, compact disk (CD), memory card or floppy disk. Such computer program products are usually portable or fixed memory units as shown in FIG. 7. The memory unit may have a storage section, a storage space or the like arranged in a similar way to the memory 620 in the electronic equipment of FIG. 6. The program code may for example be compressed in a suitable form. Usually, the memory unit includes a computer-readable code 631′, namely, a code readable by a processor such as 610. When these codes are run by the electronic equipment, the electronic equipment is caused to execute steps of the method described above.

Reference herein to “one embodiment”, “an embodiment”, or to “one or more embodiments” means that a particular feature, structure, or characteristic described in connection with the embodiments is included in at least one embodiment of the disclosure. Further, it is noted that instances of the phrase “in one embodiment” herein does not certainly completely refer to the same embodiment.

The description as provided here describes a lot of specific details. However, it is appreciated that embodiments of the present disclosure may be implemented in the absence of these specific details. Some embodiments do not specify in detail known methods, structures and technologies to understand the description unambiguously.

It should be noted that the above embodiments illustrate the present disclosure but are not intended to limit the present disclosure, and those skilled in the art may design alternative embodiments without departing from the scope of the appended claims. In claims, any reference signs placed in parentheses should not be construed as limiting the claims. The word “comprising” or “including” does not exclude the presence of elements or steps not listed in a claim. The word “a” or “an” preceding an element does not exclude the presence of a plurality of such elements. The present disclosure may be implemented by virtue of hardware including several different elements and by virtue of a properly-programmed computer. In the apparatus claims enumerating several units, several of these units can be embodied by one and the same item of hardware. The usage of the words first, second and third, et cetera, does not indicate any ordering. These words are to be interpreted as names.

In addition, it should be noted that the language used in the specification has been principally selected for readability and instructional purposes, and may not have been selected to delineate or circumscribe the inventive subject matter. Therefore, those having ordinary skill in the art appreciate that many modifications and variations without departing from the scope and spirit of the appended claims are obvious. The disclosure of the present disclosure is intended to be illustrative, but not limiting, of the scope of the disclosure, which is set forth in the claims.

The present application may be applied to a computer system/server, which may operate together with many other universal or dedicated computing system environment or configuration. Well-known computing systems, examples of environments and/or configurations adapted for use with the computer system/server include but not limited to: personal computer, server computer system, thin client, thick client, hand-held or laptop device, microprocessor-based system, set-top box, programmable consumer electronics, network personal computer, small-sized computer system, large computer system, and a distributed cloud computing technology environment including any of the above systems, etc.

The computer system/server may be described in general context of a computer system-executable instruction (such as program module) executed by the computer system. Usually, the computer modules may include routines, programs, target programs, assemblies, logic, data structures and the like, and they execute specific tasks or implement specific abstract data types. The computer system/server may be implemented in the distributed cloud computing environment in which tasks are executed by a remote processing device linked through a communication network. In the distributed cloud computing environment, the program module may be located in a local or remote computing system storage medium which comprises storage device.

1. A software detection method, wherein the software detection method comprises:
matching software information about software to be detected with problem information in one or more pre-set software problem categories, wherein the software problem categories are obtained by classifying one or more problems existing in the software, and each software problem category contains problem information related to one or more problems under the category;
and if the software information about the software to be detected is successfully matched with the problem information in the one or more software problem categories, determining that the software to be detected has one or more problems under the corresponding one or more software problem categories.

2. The method according to claim 1, wherein obtaining the software problem categories comprises:
Matching pre-obtained one or more software information of the software with corresponding software information of the software stored in the server;
if the one or more software information is not successfully matched with the corresponding software information of the software stored in the server, determining, according to the one or more software information, that the software has one or more problems, and regarding the one or more software information as problem information related to the one or more problems;
classifying the one or more problems to obtain software problem categories and recording in the software problem categories problem information related to one or more problems under the categories.

3. The method according to claim 1, wherein the matching software information of a software to be detected with problem information in one or more pre-set software problem categories further comprises:
if the software information of the to-be-detected software is not successfully matched with any problem information in any of the software problem categories, determining that the to-be-detected software does not have a problem;
aggregating the to-be-detected software free of problems to form a software problem-free category.

4. The method according to claim 1, wherein the method further comprises:
aggregating software under the same software problem category among software which are already determined as having problems into a display entry, wherein a software problem category corresponds to a display entry, and each display entry displays a corresponding software problem category and one or more software belonging to the software problem category.

5. The method according to claim 3, wherein the method further comprises:
aggregating software determined as not having problems according to the detection result to a display entry of the software problem-free category.

6. A software detection device, wherein the software detection device comprises a memory stored computer-executable instructions thereon and at least one processor to execute the instructions to cause:
matching software information about software to be detected with problem information in one or more pre-set software problem categories; and
if the software information about the to-be-detected software is successfully matched with the problem information in the one or more software problem categories, determining that the to-be-detected software has one or more problems under the corresponding one or more software problem categories;
obtaining the software problem categories by classifying one or more problems existing in the software, each software problem category containing problem information related to one or more problems under the category.

7. The device according to claim 6, wherein the obtaining the software problem categories by classifying one or more problems existing in the software comprises:
matching pre-obtained one or more software information of the software with corresponding software information of the software stored in the server;
if the one or more software information is not successfully matched with the corresponding software information of the software stored in the server, determining, according to the one or more software information, that the software has one or more problems, and regard the one or more software information as problem information related to the one or more problems; and
classifying the one or more problems to obtain software problem categories and recording in the software problem categories problem information related to one or more problems under the categories.

8. The device according to claim 6, wherein the matching software information about software to be detected with problem information in one or more pre-set software problem categories further comprising:
if the software information of the to-be-detected software is not successfully matched with any problem information in any of the software problem categories, determining that the to-be-detected software does not have a problem; and
aggregating the to-be-detected software free of problems to form a software problem-free category.

9. The device according to claim 6, wherein the processor executes the instructions further to cause:
aggregating software under the same software problem category among software which are already determined as having problems into a display entry, wherein a software problem category corresponds to a display entry, and each display entry displays a corresponding software problem category and one or more software belonging to the software problem category.

10. The device according to claim 8, wherein the processor executes the instructions further to cause:
aggregating software determined as not having problems according to the detection result to a display entry of the software problem-free category.

11. (canceled)

12. A computer-readable medium in which having instructions stored therein that, when executed by at least one processor, cause the processor to perform operations for detecting software, which comprising:
matching software information about software to be detected with problem information in one or more pre-set software problem categories, wherein the software problem categories are obtained by classifying one or more problems existing in the software, and each software problem category contains problem information related to one or more problems under the category; and
if the software information about the software to be detected is successfully matched with the problem information in the one or more software problem categories, determining that the software to be detected has one or more problems under the corresponding one or more software problem categories.
